(19) United States
(12) Patent Application Publication
(10) Pub. No.: US 2018/0225739 A1
(43) Pub. Date: Aug. 9, 2018

(54) RECOMMENDATION SYSTEM

(71) Applicant: Piksel, Inc., Wilmington, DE (US)

(72) Inventors: Philip Shaw, York (GB); Peter Heiland, Dover, MA (US); Ralf Tillmann, Mannheim (DE); Mark Christie, London (GB); Kristan Bullett, York (GB); Miles Weaver, York (GB); Peter McGettigan, North Yorkshire (GB)

(21) Appl. No.: 15/749,292

(22) PCT Filed: Aug. 1, 2016
(86) PCT No.: PCT/EP2016/068321

§ 371 Date: Jan. 31, 2018

Related U.S. Application Data
(60) Provisional application No. 62/199,649, filed on Jul. 31, 2015.

(51) Int. Cl. G06Q 30/06; G06F 17/30

(52) U.S. Cl. CPC G06Q 30/0631; G06F 17/30867

(57) ABSTRACT

There is disclosed a recommendation server comprising: an input interface configured to receive an indication from a user device of a user behaviour; a recommendation engine configured to compile recommendations for a user; and a processor configured to identify an anomaly between the user behaviour and the compiled recommendations for the user. There is also disclosed a computer-implemented method of generating an enquiry message, the method comprising; monitoring behaviour of a user when engaging with a computer device; determining that the user has engaged with the user device in a particular context in which it is predetermined that the user will respond to the enquiry message; selecting a template from a set of templates; populating the selected template with data relating to the enquiry; and transmitting the enquiry message to the user device based on the populated selected template.

### BACKGROUND TO THE INVENTION

### Field of the Invention

The present invention relates to a recommendation system or to a system in which the behaviour of a user is monitored.

### Description of Related Art

Recommendation systems exist which attempt to provide a user with recommendations for content that they may wish to consume based, for example, on their historical preferences as recorded by the system, and/or on user profile data. Improvements in such systems have recently been developed and are described in earlier patent applications, the contents of which are herein incorporated by reference in their entirety. In these systems, recommendations also take into account the context of a user, taking into account his past behaviours.

The present application incorporates by reference all subject matter included in the following applications:

WO 2016 020463 (based on U.S. 62/033,520, known as Navigational Paradigm);

WO 2016 020464 (based on U.S. 62/033,445, known as Context Driven Content);

WO 2016 020466, WO 2016 020467, WO 2016 075161 (based on U.S. 62/033,448, known as Eco System);

WO 2016 020465 (based on U.S. 62/033,471, known as Sequence of Delivery);

WO 2016 020462 (based on U.S. 62/033,473, known as Swipe Based Volume Control); and

GB 2532405 (based on GB 1416052.7, known as Wearables).

Such a system includes a processor operating a selection program which is arranged to receive a context identifier or label for identifying different contexts, and for selecting a set of items (e.g. activity items or actions) in dependence on the context.

Thus, the context of a user can be used to enhance recommendations. Context can also be used to enhance recommendations for user activities or other items that a user may be engaged in at his user device. A context such as, for example, commuting, on holiday, etc. can be derived from a set of raw context data, for example, from users of a user device.

In some scenarios a recommendation may not have been calculated or offered to a user. In other scenarios recommendations, whilst made, may not always be taken by a user. A user behaviour may be independent of a recommendation made. In some cases a user behaviour may be associated with a candidate recommendation, which was not included in actual recommendations made. In some cases the user behaviour may simply not have been contemplated for recommendation.

It is an aim to provide improvements relating to scenarios where the user behaviour is unexpected.

### SUMMARY OF THE INVENTION

In one aspect there is provided a recommendation server comprising: an input interface configured to receive an indication from a user device of a user behaviour; a recommendation engine configured to compile recommendations for a user; and a processor configured to identify an anomaly between the user behaviour and the compiled recommendations for the user.

The user behaviour may be associated with a user engagement with the user device.

The user behaviour may be one or more of: a user choice of an item, a user action, or a user activity.

The processor may be configured to determine the anomaly in dependence on identification of the user behaviour as not being associated with recommendations for the user from which the compiled recommendations are collated.

The processor may be configured to determine the anomaly in dependence on identification of the user behaviour as not being associated with a compiled recommendation, but as being associated with a recommendation from which the compiled recommendations was collated.

The recommendation engine may be further configured to compile recommendations for the user in dependence upon user context, and the processor is further configured to identify the anomaly in dependence on a context of the user behaviour.

The processor may be configured to generate metadata describing the anomaly.

The recommendation server may further comprise a memory configured to store the identified anomaly.

If the context is a known context for the user, the known context may be updated in dependence on the anomaly.

If the context is not a known context for the user, a new context may be created for the user based on the anomaly.

The processor may be configured to enhance future recommendations for the user in the same context based on the anomaly.

In this aspect a computer-implemented method may also be provided, corresponding to the recommendation server. A computer program may be provided for executing the method. A computer program store, or non-transitory medium, may be provided for storing a computer program to perform the method.

In this aspect of the present invention, there is also provided a recommendation server comprising: a recommendation engine for compiling recommendations for a user; an input interface for receiving an indication from a user device of a user choice; a processor for determining that the user choice is for an item beneath a recommendation threshold; and an output interface for providing a request for clarification of the choice from a user device associated with the user.

The recommendation server can be implemented by one or more computers or processing devices, which generally, but not always, will be distinct from the user device itself. A recommended item may be content, an activity or any other item considered of interest to a user.

“Anomalies” are items (e.g. activity or content which fall outside a recommendation regime for a particular user). So-called positive anomalies are those items which a user has chosen but which would not have been recommended by the system, for example, because they fall below a recommendation threshold. So-called negative anomalies are items which are recommended to a user, but which are rejected by the user. An improvement provided herein is to identify positive anomalies and enable the system to receive feedback from a user about the item they have chosen, to inform further recommendations. In some cases negative anomalies can also trigger a request for feedback.

The identification of anomalies is preferably carried out by the server. Identification of a positive anomaly is based on comparing what the user has chosen (as advised by the user device to the server) with what the system may have recommended to that user in a particular context.

The recommendation engine may associate a level with each recommendation, and the determining step may identify that the user choice is for an item which has a level below the recommendation threshold. That is, the recommendation engine would not have chosen to recommend it. The recommendation engine may determine that the user choice has not been included in the recommendations by the recommendations engine, in order to identify that it may be an anomaly.

The recommendation engine, once determining that the user choice is beneath a recommendation threshold, may store the user choice in an anomaly memory. This step of storing may be done in response to a determination that a user is genuinely interested in this choice, and is not “browsing”. This can be achieved for example, by detecting a scroll rate of an article suggestive of a normal reading rate; viewing more than a few seconds of a video; or clicking on a “more like this” link.

In another aspect there is provided aa computer-implemented method of generating an enquiry message, the method comprising: monitoring behaviour of a user when engaging with a computer device; determining that the user has engaged with the user device in a particular context in which it is predetermined that the user will respond to the enquiry message; selecting a template from a set of templates; populating the selected template with data relating to the enquiry; and transmitting the enquiry message to the user device based on the populated selected template.

The set of templates may include a plurality of sub-sets of templates, each sub-set being associated with a different enquiry complexity, the method further comprising determining an appropriate complexity for the enquiry based on the determined context, and selecting the template accordingly.

The selected template may be populated in dependence on metadata associated with the enquiry message.

The enquiry may relate to a previous user behaviour.

The enquiry may relate to a relationship between a previous user behaviour and recommendations for the user.

The enquiry may relate to an anomaly identified between the previous user behaviour and recommendations for the user.

The step of selecting a template may be further dependent on a user profile or user history data.

The computer-implemented method may further comprise receiving a response to the enquiry message, wherein the response is used to enhance future recommendations for the user.

A recommendation server for performing the method is also provided in this aspect. In this aspect a computer-implemented method may also be provided, corresponding to the recommendation server. A computer program may be provided for executing the method. A computer program store, or non-transitory medium, may be provided for storing a computer program to perform the method.

Another aspect of the invention provides a computer implemented method of generating an enquiry message containing data to control a user interface of a computer device to output an enquiry based on the enquiry message, the method comprising: monitoring behaviour of a user when engaging with a computer device; determining that a user has made a user choice to engage with an item presented at the user device in a particular context; providing to an inquisition engine a textual description relating to the user choice, the inquisition engine performing a semantic analysis of the textual description to output semantic entities and data defining each semantic entity; supplying the semantic entities and context data defining the context to a template selector, the template selector selecting a template from a set of templates; populating the selected template with the data defining each semantic entity to generate the enquiry message. The template selector may also receive user profile or user history data.

The formulation of a request for clarification could be handled locally or by the server (or by another remote computer which receives information about the anomaly and other pertinent information).

The request for clarification provided by the output interface may comprise transmitting a message for display to the user on a user display of a user device associated with the user. Responsive to displaying the message, there may be received an input at a user interface of the user device. The receipt of the input at the user interface may cause a message to be transmitted to the input interface of the recommendation server.

The recommendation server may include a context engine for determining a current context of the user. The recommendation engine may be adapted to control the output interface to transmit a message requesting for clarification of the choice from a user device associated with the user in dependence on the current context of the user. This message may be transmitted in dependence on the context of the user indicating that the user is likely to respond to the request for clarification. This context may be indicated by the user activity.

A request for clarification can be issued to a user based on one anomaly, or it can consolidate several anomalies into a single request for clarification.

An inquisition engine may construct the request for clarification. The inquisition engine may communicate with a query database in order to extract an appropriate query for the clarification. The inquisition engine may communicate with the query database in dependence on the context. The query database includes a set of query templates.

The recommendation server uses context to determine when the clarification request should be made to the user. Context may be based on user activity, e.g. to indicate a time of day, location, or other context for a user response to a request for clarification. “Context” can be a variety of other matters, and can be derived from a set of raw context data. It is described more fully in the above listed cases.

The inquisition engine uses context to determine how the clarification request should be made to the user. The user activity may indicate a period of time available for a user response to a request for clarification. Consequently, the context dictates to the inquisition engine that the clarification query may be constructed in dependence on the time available. In particular, a simple or complex request can be formulated depending on the context. In this case, the context can include, amongst other things, the user's propensity to respond to such requests in similar situations. This propensity is in fact an additional piece of contextual data to define a context. Other contextual data items are described at length in the listed cases mentioned above.

In dependence on a short time available (or in other appropriate contexts), the inquisition engine communicates with the query database and constructs a simple query requiring a short user response. In dependence on a relatively longer time available or in other appropriate contexts), the inquisition engine communicates with the query database and constructs a complex query requiring a relatively longer user response.

To construct a simple or complex request, a database may store representations of various expressions that can be evaluated using a semantic analysis of anomalies. The results of these evaluations may indicate whether certain question templates can be used or not. A system administrator may define these expressions and templates.

### BRIEF DESCRIPTION OF THE FIGURES

For a better understanding of the present invention and to show how the same may be carried into effect, reference will now be made by way of example, to the accompanying drawings, in which:

FIG. 1 is an example schematic block diagram of the architecture of a recommendation system;

FIG. 2 is a flow diagram illustrating an example of the identification of anomalies;

FIG. 3 is a schematic diagram illustrating an example of the construction of queries;

FIG. 4 is a schematic block diagram illustrating an example of the architecture of a query construction system;

FIG. 5 is a flow chart of an example query construction process; and

FIG. 6 is a schematic example view of a portal showing simple and complex questions presented to a user.

### DESCRIPTION OF PREFERRED EMBODIMENTS

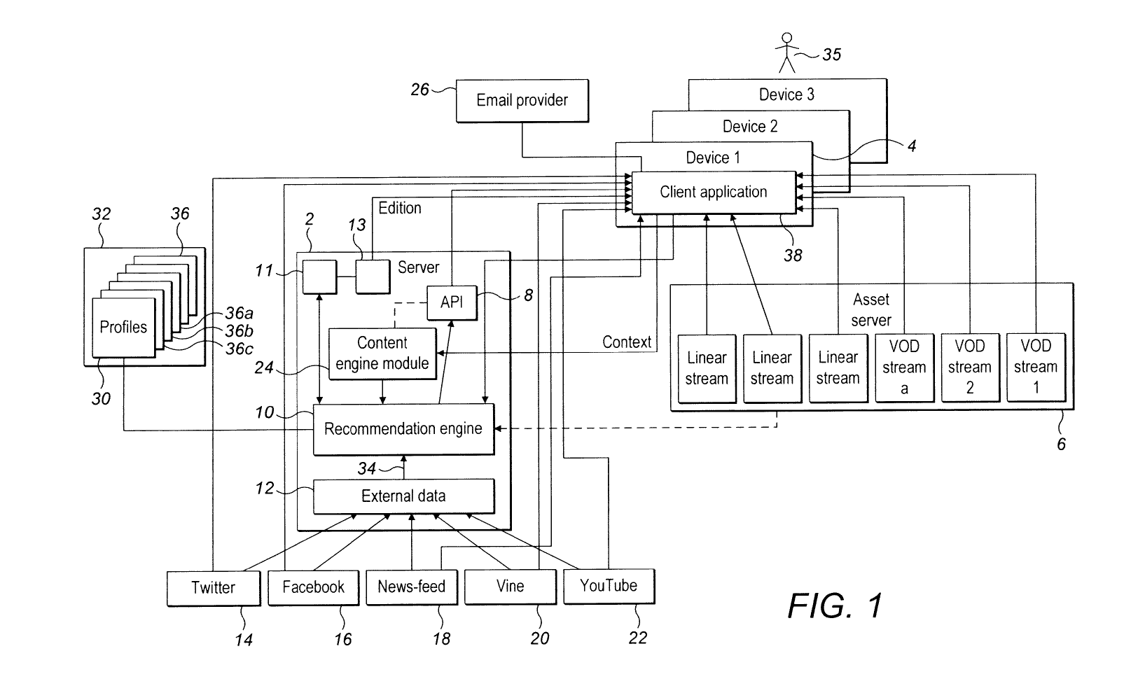

Examples are described with reference to a recommendation engine. FIG. 1 illustrates an example system that provides recommendations (of content, activities, actions or any other item) to a user. Such a system is fully described in the listed cases which are incorporated herein by reference. The example system of FIG. 1 is now described.

A control server 2, being a content delivery server, is connected to a user terminal 4 of a user 35 by any suitable communication network, whether wired or wireless. The network is not shown in FIG. 1 for reasons of clarity. The user terminal 4 is also in communication with an asset server 6 via a same or different network.

The asset server 6 supplies video assets which can be linear stream assets or VOD assets. The user terminal 4 requests assets from the asset server 6 based on information which it receives from the content delivery server 2. Although a single asset server 6 is illustrated and described, a plurality of asset servers may be provided.

The content delivery server 2 comprises: an application program interface (API) 8, for example a REST API; a recommendation engine module 10; a data aggregator module or external data module 12; and a context engine module 24. The recommendation engine module 10, data aggregator module or external data module 12 and context engine module 24 are all implemented by a suitably programmed processor or processors (not shown).

The data aggregator module 12 connects to a number of content sources to the content delivery server 2, again by any suitable communication network. In this example, these sources comprise a Twitter feed 14, a Facebook feed 16, a news-feed 18, a Vine feed 20 and a YouTube feed 22. These are exemplary only and it will readily be appreciated that other content sources may be appropriate.

The content delivery server 2 has access to user profiles 30, either in a local memory (not shown) or in a storage facility 32 accessible to the content delivery server 2.

The data aggregator module 12 receives information from the multiple sources 14, 16, 18, 20, 22 and monitors their content so as to be able to supply content based information 34 to the recommendation engine module 10.

In one mode, or context setting, the recommendation engine module 10 may operate based on the content-based information supplied by the data aggregator module 12 to recommend video assets which can be accessed by the user terminal at the asset server 6. Thus the recommendation engine module 10 has information about all assets available in the asset server 6, and operates to recommend assets to the user 35 (via the user device 4) based on the content-based information 34 it receives from the data aggregator module 12.

In another mode, or context setting, the recommendation engine module 10 operates based on user profile or behaviour history, without referencing the content from the multiple content sources.

The mode of operation depends on how the user interacts with the recommendation engine.

The user terminal 4 is labelled “Device 1”. A user 35 may own multiple devices, which are indicated in FIG. 1 by the labelling Device 2, Device 3. Each of these devices is a user terminal. For example, a user 35 might own a tablet, a smartphone, a laptop and a TV set. The user may be using one or more devices at any particular time. In one particular use case the user may, for example, be using a smartphone (Device 1) and a TV set (Device 2), with the smartphone acting as a companion to the TV set. In any event, all the devices are capable of communicating with the content delivery server 2 when they are active and logged on by the user 35.

It will readily be appreciated that a single user is being discussed, but in practice the content delivery system operates with a large number of different users, where all users have profiles and sub-profiles set up for them respectively. Only a single profile and its sub-profiles is shown in FIG. 1 for the sake of convenience.

In practice there may be a plurality of additional users, and each additional user may be associated with one or more user devices. Each user device may provide an input to the context engine of the context server 2. The context for any given user may be generated, at least in part, on inputs received from user devices other than the specific user device 4.

In FIG. 1, connections are shown between the user terminal 4 and the content delivery server 2. In particular, the user terminal 4 feeds data back to the context engine module 24 and the recommendation engine module 10. In addition, the devices can communicate with the asset server 6 to obtain assets from the asset server 6.

In some of the examples described herein, the system is capable of delivering context recommendations based on the type of device that a user is currently logged in to.

The user 35 has a profile 36 in the user profile 30. In this user profile are stored preferences and other information about the user 35 to allow recommendations to be made based on information personal to that user. In the present system, the user can set up individual sub-profiles, 36a, 36b, 36c, etc. which allow the user to have different preferences in different situations that the user may find themselves in. This means that recommendations based on the user sub-profiles could vary even for the same user when that user is in different settings.

In addition to providing recommendations based on device type, the system may provide recommendations based on context. Context may be determined based on context data such as location, time and available time as will become evident from the examples discussed later. As noted above, the context data used for determining a context for a user may be provided by a plurality of user devices, including user devices associated with other users.

The multiple content sources 14 to 22 are also accessible to the user terminal 4 itself as denoted by the various arrows. The purpose of these connections is to allow the user terminal 4 to access content from the multiple sources 14 to 22 when invited to do so on the instructions received from the content delivery server 2. Thus, these sources operate in two ways. Firstly, they provide content to the data aggregator module 12 for driving the recommendation engine module 10, and secondly they provide content items for display to a user at the user terminal, when they are recommended to the user terminal and when the user selects one or more of them to consume.

The context engine module 24 influences the recommendation engine module 24 so that the recommendations are based on the context of a user. The context of a user is perceived here to govern the behaviour of a user and therefore to affect their likely preferences for engaging with content. The likely context based preferences for a user can be determined by monitoring historical behaviour of a user, or can default to certain conditions based on information about the user, for example, in the user profile. A user can set or override context parameters associated with the context engine module 24 should they wish to do so. The context engine module 24 may also influence the recommendation engine to define the number and type of assets to be recommended to a user, based on context.

The user device 4 executes a client application 38 which cooperates with the context engine module 24 of the content delivery server 2 to deliver context based recommendations.

Also shown in FIG. 1 is an email provider 26, connected to the user terminal 4.

In the described examples content recommendation is referred to only as an example. In general, and as noted elsewhere, a user is provided with recommendations, which may for example be an item, an action, or an activity.

The system may continuously improve the quality of the choices made by its recommendation engine 10 by monitoring the way in which the user 35 responds to and interacts with each recommendation.

It can be understood that the recommendation system has a context engine module 24 which feeds the recommendation engine and causes it to make different curation decisions for a given user in dependence on that user's context. Any feedback provided either directly or indirectly by the user and arising from those decisions becomes associated with either the context at the time of recommendation, or the context at time of consumption/action or both. In this way, this feedback can be used by the system to improve future recommendations.

In a first aspect there is provided an identification of an anomaly between a user behaviour and an actual or possible recommendation.

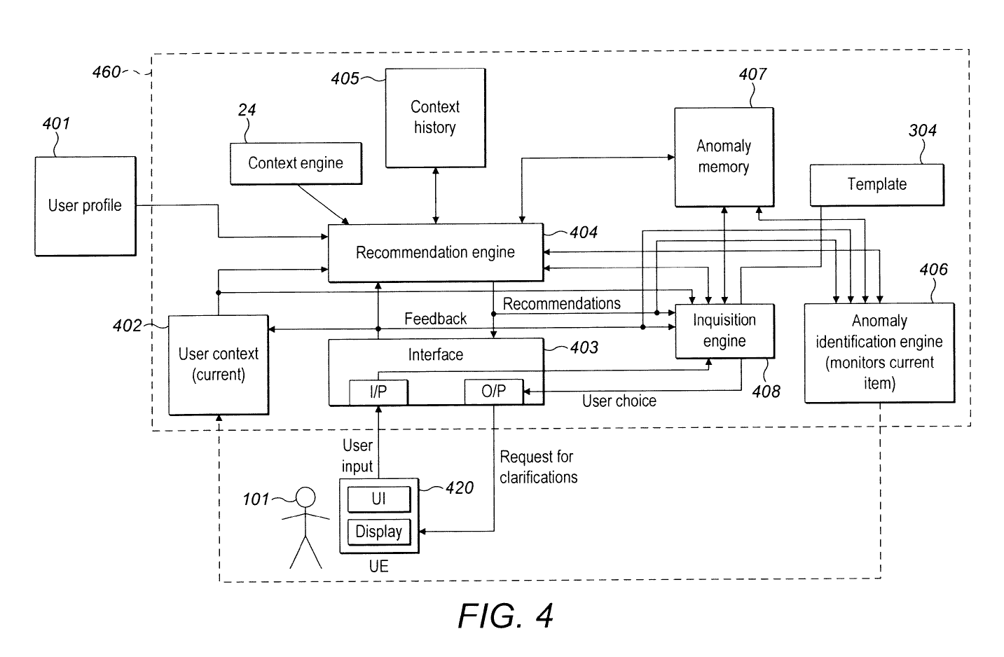

With reference to FIG. 4 there is illustrated elements of the recommendation system of FIG. 1 which are applicable for describing examples, and in addition includes further features of the recommendation system which are associated with these described examples.

As shown in FIG. 4, a recommendation server (generally denoted by reference numeral 460) includes a recommendation engine 404 (corresponding to the recommendation engine 10 of FIG. 1), a context engine 24 (corresponding to the context engine module 24 of FIG. 1), a context history module 405, an anomaly memory 407, an interface module 403, a user context module 402, and an anomaly identification engine 406. Also shown is a user profile module 401 (which may correspond to the module 32 of FIG. 1) which in this example is external to the recommendation server 460.

In addition there is shown a user 101 who may correspond to the user 35 of FIG. 1, and a user equipment 420 associated with the user 101.

The user 101 is generally utilising the recommendation server 460 shown in FIG. 1, and may also be using other content systems. Examples described herein are concerned with identifying anomalies, where there is an anomaly between a user behaviour and a recommendation which has been made or would have been made to the user.

The context engine 24 provides inputs to the recommendation engine 24, and a user context is thus able to drive the compilation of a recommendation for a user. As noted above a user context may be determined by inputs from multiple servers, and the context engine processes this information to provide a user context to the recommendation engine. In addition the user profile module 401 provides inputs to the recommendation engine 404 to help the recommendation engine utilise a user profile to provide recommendations to the user. The recommendation engine additionally communicates with the context history module 405, in order to obtain information relating to the context history of users.

The interface 403 provides an interface for the recommendation engine 403 to interface with the user equipment 420. The user equipment 420 delivers user inputs, and any other appropriate user data, to an input block of the interface 403. An output block of the interface 403 generates signals to the user equipment.

The interface 403 communicates with the recommendation engine 404, and receives recommendations from the recommendation engine 403 to be delivered to the user equipment. The recommendation engine is configured to compile recommendations for a user. The recommendation engine 404 receives feedback from the user interface 403. The feedback may include information as to the user behaviour. The input interface thus is configured to receive an indication from a user device of user behaviour. The user behaviour may be associated with user engagement with the user device.

The anomaly identification engine 406 is a processor which receives the recommendations which are sent by the recommendation engine 404 to the user equipment, and which also receives the feedback which is sent to the recommendation engine 404 from the user equipment. Thus feedback indicates the user behaviour, which is associated with a user engagement with the user equipment. As will be discussed below, these inputs allow the anomaly identification engine 406 to determine anomalies. The anomaly identification engine is connected to the anomaly memory 407. The anomaly memory 407 is also connected to the recommendation engine 404.

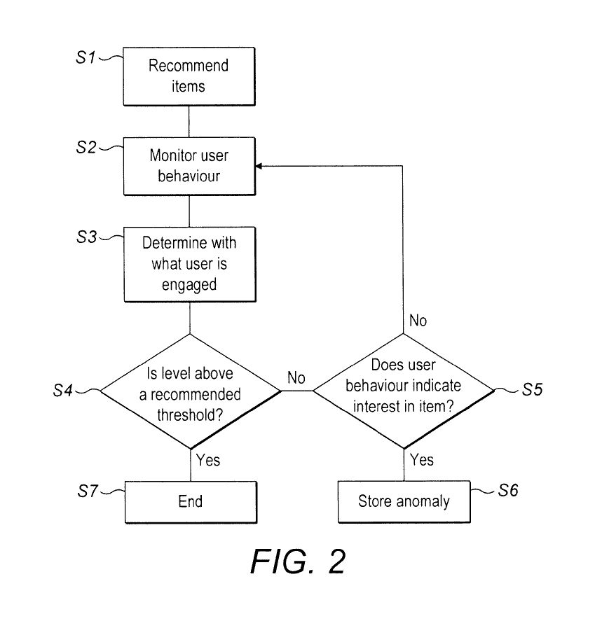

Typically, a user can perform any permitted action in a system and is not limited to those which are recommended. The system can identify that a user has made a personal choice to consume a particular item, take a particular action or conduct a particular activity. This may be one that the recommendation system, operating in its usual way for that user, would not have recommended (or has, in fact, not recommended). These are referred to as “positive anomalies” (abbreviated herein to “anomalies”). It should be clear here that in general an anomalous user behaviour is identified. This user behaviour may be the consumption of content that the recommendation engine did not recommend, but in general an anomaly is a behaviour that the system would not have expected. The identification of such anomalies in a recommendation system is now described with further reference to the system of FIG. 4 and the process of FIG. 2. IT should be understood that this is a specific example which is associated with recommendations being made. However more broadly recommendations may not be made, or even calculated, and the user behaviour simply monitored.

The identification of anomalies, in combination with further clarifications, enable the detection of new contexts, on the specification of new contexts, so the recommendation engine can consider them in future contexts.

There are a number of reasons why an anomaly may be identified.

The anomaly identification engine may be configured to determine an anomaly in dependence on identification of the user behaviour as not being associated with a compiled recommendation, but as being associated with a recommendation from which the compiled recommendations were collated. The recommendation engine may have a set of candidate recommendations, and from that set compile a list of recommendations which are sent to the user device. To achieve this a threshold may be used, and only that those recommendations exceeding the threshold are included on the compiled recommendations. Thus the anomaly identification engine receives the raw recommendations from the recommendation engine, as well as the compiled recommendations sent to the user device via the interface.

The anomaly identification engine may alternatively be configured to determine an anomaly in dependence on identification of the user behaviour as not being associated with recommendations for the user from which the compiled recommendations are collated.

These are examples, and other techniques for determining anomalies may be provided.

As will be described in the example of FIG. 2, a recommendation system monitors every action taken by a user, and compares these against the list of actions it might have recommended in the given context, whether an explicit set of recommendations was made or not, or whether recommendations where even calculated. By doing so, in this example the recommendation system can identify potentially anomalous actions or content items that do not fit its view of likely user actions/content. It should be noted that FIG. 2 illustrates an example, and as discussed herein this is a specific example of a broader principle.

In the case of an anomaly being identified, it is beneficial to allow the system to maintain a list of these anomalies. As will be discussed hereinafter, by maintaining a list of identified anomalies at a later time, the list can be referred to so as to use one or more of the anomalies to construct at least one question for presentation to the user, answers to which enable it to improve future recommendation choices, and/or increase or improve the quality of the multiple contexts of a user which the system accesses. Examples relating to this question construction will be described later.

The anomaly memory 407 stores a list of anomalies.

The specific example process for identifying anomalies is now further described with reference to FIG. 2.

At a step S1 in FIG. 2, the recommendation engine 404 recommends items to a user. Whilst in this example recommendations are made to the user, in fact no recommendations may have been made.

At step S2, the behaviour of the user is monitored by the anomaly identification engine 406. This monitoring comprises monitoring the consumption of content by the user. The anomaly identification engine 406 has a connection to receive the feedback to the recommendation engine 404 from the user device, and also receives any recommendation sent, and communicates with the recommendation engine 404.

The recommendation engine uses its knowledge of prior consumed content/actions, etc. to improve future recommendations for a given user. As will be described further below, the system described herein preferably has an ability to pose more detailed questions to allow it to qualify any adjustments to the recommendations rather than simply accepting them.

At step S3, it is determined with what the user is engaged.

At step S4 it is determined whether the user is engaged with content, or engaged in an activity, which the recommendation system would have recommended, etc. It is not required that the recommendation system has provided recommendations—although it may have. In an example, it may be determined whether or not an item with which the user is engaged is above or below a recommendation threshold, or whether the system actually did recommend it. If the item is one which is above a recommendation threshold, or one which was actually recommended, the process ends as denoted by step S7, as no anomaly arises.

If, however, the item was below a recommendation threshold, and/or was not actually recommended to a user, at step S5 it is determined whether or not the user behaviour indicates an ongoing interest in the item. If it is determined that the user is engaged with the item, then the scenario is identified as an anomaly, and the anomaly is stored as denoted by step S6.

This example is not limited to a recommendation being associated with a context, although it may be. For example the system may determine whether it would have made that recommendation in the current context of the user. In general it is determined whether the system would have made that recommendation based on whatever the basis for recommendations is.

The system is therefore able to identify an anomaly, whether or not an actual recommendation was made, and state that anomaly.

The anomaly identification engine 406 determines the identification of an anomaly, and stores the anomaly in the anomaly memory 407. A connection is therefore provided between the anomaly identification engine 406 and the anomaly memory 407. Preferably the anomaly identification engine 406 stores in the anomaly memory 407 metadata associated with the anomaly. The metadata includes: a description of the underlying anomalous behaviour taken by the user, such as why it was determined anomalous; the context of the user at the time the anomaly was identified, the probability (if any) of recommending such an action/activity in that context; and the metadata of any associated content. This is not an exhaustive list, and the metadata may include some or all of this, and/or other information.

There are multiple branches for defining what this unexpected behaviour could be and consequently how it would be considered by the system and the related recommendation engine. Examples are set as follows.

An unexpected behaviour can be an activity that was unknown to the system before, and was therefore not covered by any context definition for a given user. For instance a user has bought a new tablet and an associated contract with enormous download rate. Before that time the user did not watch videos on his mobile device when he went to work in the morning. Now with his new equipment and download rate he starts to watch videos in the train on weekdays mornings. This anomaly is used to define a new context for that user.

An unexpected behaviour can be an activity that was unknown to the system before but is valuable to be added to existing contexts. For instance, the user has only consumed TV-series on Monday evenings and did not consume sports, although it is known that he loves to watch football on Saturdays evenings. Now after the football league has decided to have one Monday game each week, the user starts to watch them on Monday. This anomaly can be used to be added to an existing context as additional information (by allowing and searching for football on Monday, or perhaps by decreasing the focus on TV series for Monday evenings).

An unexpected behaviour can be the consumption of items that were not considered for the recommendation process before. For instance the user has updated his satellite configurations and has stored new channels on his TV. Now items of these channels can be considered for the recommendation process that were not known before.

An unexpected behaviour can be the consumption of items that were not recommended to the user (the use case of an item below a threshold)—as he shows a new starting favour for golf tournaments.

In a second aspect an enquiry is generated, using a template, responsive to monitoring user behaviour. This can advantageously be used in conjunction with identification of an anomaly as described above, but is not limited to identification of an anomaly.

In a second example described herein, an enquiry message is used to trigger the generation of a query using templates. Merging with the first example, such a query may be generated in response to identification of an anomaly.

As such, in response to locating an anomaly, the system may thus pose questions to a user about his choice. The system can:

1. Determine when to present questions to users;

2. Determine a level of complexity for each question; and

3. Implement methods for casting a question with a desired complexity.

Such methods are broadly applicable, and more broadly applied than the examples relating to identification of anomalies. However for ease of reference an example is now further described which relates to the identification of anomalies.

In order to facilitate this further example, the recommendation server 460 of FIG. 4 additionally includes an inquisition engine 408, a templates module 304, and a user context module 402.

In general, in this second aspect the system generates an enquiry message to a user in dependence on the user context. The user context module 402 monitors the current user context, by receiving the feedback signal provided to the recommendation engine 404, and also receiving the output of the context engine 24.

The user context module 402 monitors the current user context to identify, for the user a particular context in which it has been predetermined that the user will respond to an enquiry. This may have been predetermined, for example, based on the user having responded to an enquiry in particular contexts previously.

On detection of such a particular context, the user context module 402 notifies the inquisition engine 408, and the inquisition engine 408 accesses the templates module 304 to create an enquiry message.

The templates stored in the template module are preferably each allocated to a particular query. However each template is preferably comprised of a plurality of sub-templates, each associated with different levels of complexity. When the user context module 402 identifies the particular context, it will also notify the inquisition engine of a complexity associated with that context (such as the time available for the user to respond), and the inquisition engine will select a sub-template according to the complexity. The complexity may vary for anomalies of different types.

The inquisition engine is connected to the anomaly memory, and accesses the anomaly data associated with the anomaly to populate the template. When the particular context is identified for the user, and the inquisition engine 408 notified, the inquisition engine will first check by accessing the anomaly memory 407 whether there is one or more previously identified anomaly for the user. If so the anomaly (preferably the anomaly metadata) is retrieved, and based on the retrieved anomaly metadata the appropriate template for the type of anomaly (i.e. the type of enquiry) selected. The sub-template is then selected based on complexity, and populated.

The inquisition engine 408 then forwards the populated template to the interface 403, specifically the output block thereof, to transmit an enquiry message based on the template to the user device.

A response to the enquiry message is received at the input block of the interface 403, which is then forwarded to the inquisition engine 408. The inquisition engine analyses the response and provides information based on the response to the recommendation engine 404.

Following receipt of the response, the inquisition engine may delete the anomaly from the anomaly memory 407, or mark the entry to indicate an enquiry of a certain level of complexity relating to the anomaly has been addressed.

The above sets out the general case in which a query message will be generated to a user based on their current context, and based on the existence of an anomaly (noting that this query message generation is not limited to an anomaly). In general, the generation of an enquiry message will be triggered in dependence on: (i) identification that a user is prepared to answer questions as all; (ii) that the user is ready to answer questions about an anomaly for that user which has been stored; and (iii) that the user is ready to answer questions of a given complexity.

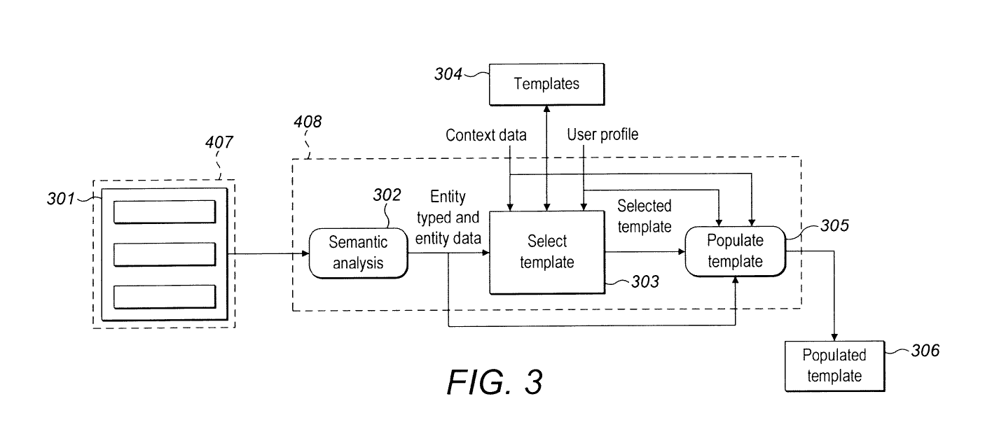

With further reference now to FIG. 3, there is illustrated in more detail functionality of an exemplary recommendation system, such as that of FIGS. 1 and 4, which can be further modified to allow this further example to be utilised where a query is generated responsive to an anomaly being identified. It will be understood that this relates to a specific example, and as above this example is representative of a more generic solution.

It will be understood that certain aspects of the recommendation system of FIG. 4 are provided in order to facilitate such a query-based functionality, including specifically the inquisition engine 408, the templates module 304, and the user context module of FIG. 4. If no such query generation is being utilised, then these elements of FIG. 4 are not required.

The templates module 304 of FIG. 4 is shown in FIG. 3. Additionally shown in FIG. 3 is further detail of the inquisition engine 408. The inquisition engine 408 in the example of FIG. 3 further includes a semantic analysis module 302, a select template module 303, and a populate template module 305. A populated template module 306 is shown separate to the inquisition engine 408.

The select template module 303 of the inquisition engine 408 receives context data and user profile information, in addition to the templates from the templates module 304. This is provided by the context engine 24 and the user profile module 401.

The inquisition engine 408 receives as an additional input an output from the anomaly memory 407, which as above may be stored anomaly metadata. In this example, this is represented as a textual description 301 which is input to the semantic analysis module 302.

The output of the semantic analysis module 302 provides an input to the select template module 303, and an input to the populate template module 305. The output of the select template module 303 provides an input to the populate template module 305. The populate template module 305 additionally receives the user profile information and the context data. The populate template module 305 generates the populated template in the populated template module 306.

If an anomaly is detected, the recommendation system preferably checks to see if the present context of the user is one in which a user may respond to a question about this anomaly as described above. The inquisition engine 408 is triggered to send a query to the user when it is determined that a particular context has been identified. As described above, when this particular context is identified the trigger is provided, but the query message may also be sent ‘on the fly’ if the current user context in which the anomaly arises is also one in which it has been predetermined that the user will respond to a query for an anomaly of a given type. This could include identifying the time a user has available based on previous behaviour in a similar situation. The inquisition engine 408 presents a question or questions to the user, if it is likely the user will respond. The question is displayed on the user interface (UI) of the user equipment (UE) in a text form with fields, for a user to enter answers.

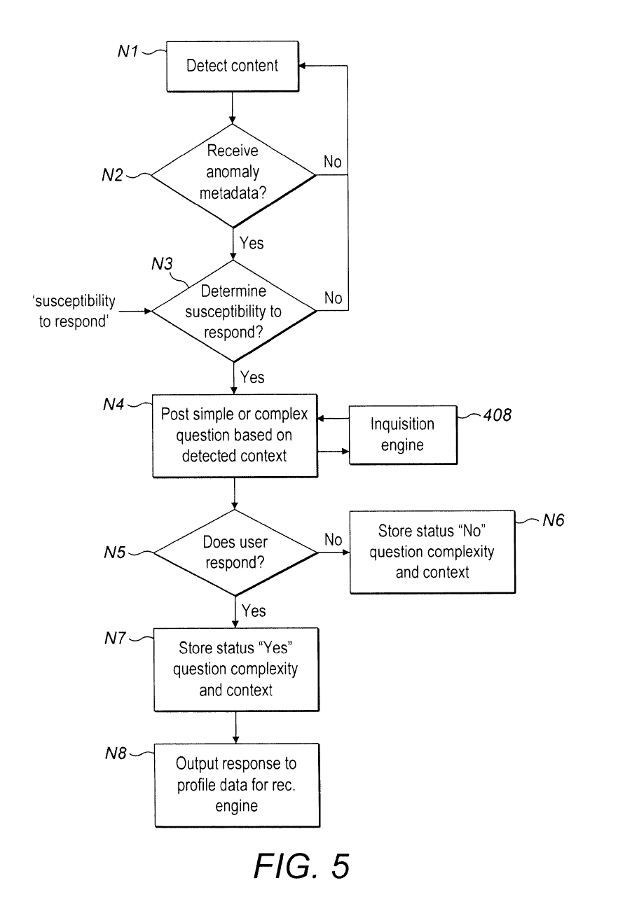

The operation of this example is now further explained with reference to FIG. 5.

According to FIG. 5, the current context of a user is detected at step N1. The current context is provided to the recommendation engine 402 by the user context module 402.

In a step N2, the recommendation engine 402 retrieves the metadata for all anomalies for the user from the anomaly memory 407. If there are no anomalies, then the process returns to step N1.

In a step N3, the recommendation engine 402 then determines the ‘susceptibility to respond’, i.e. the likelihood of the user responding to a query concerning one or more of the anomalies in that context. If this likelihood is above a threshold, then the trigger is provided for the inquisition engine to perform its task.

The process then moves on to step N4. At N4 the inquisition engine 408 posts a simple or complex question based on the detected context. This is carried out by the inquisition engine 408 in a manner described below.

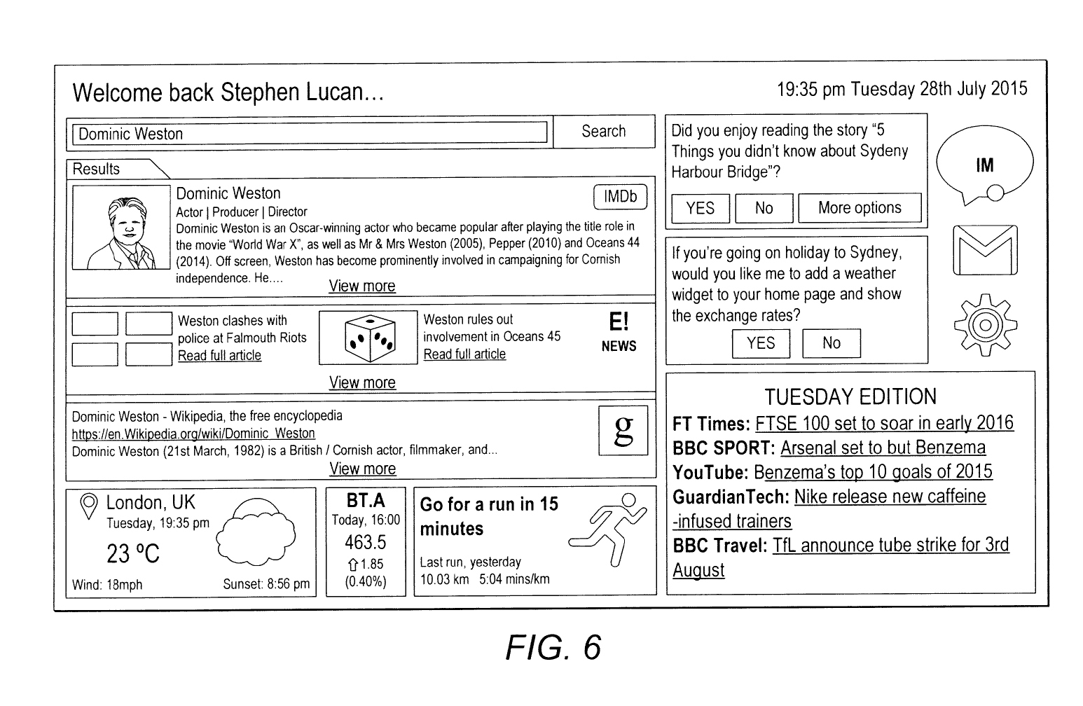

The step N4 poses a request for clarification (a query) to a user which is presented to the UE of a user so that it can be displayed on the display for the user to engage with. An example of a display is shown in FIG. 6.

A user is given the opportunity to respond to the question.

At step N5 it is determined whether or not the user has responded.

If he has not, the status of “no” is stored along with the complexity of the question and the context in the anomaly memory 407. This is represented by step N6.

If he does respond, the status of “yes” is stored along with the question complexity and the context. This is represented by step N7.

These statuses, question complexities and context are used by the recommendation engine 404 to update the context history for a user and provide more information about the likely susceptibility to respond which can be used at step N3 in the future.

At step N8, following step N7, if there is a response it is output to the profile data for the recommendation engine to work on in the future when providing recommendations.

The system may use its understanding of the user's willingness to respond to questions, in a given context, to determine the number and complexity of the questions themselves. This information is utilised in step N4, to determine the complexity of a question posed in a given user context.

The ‘susceptibility to respond’ is, in itself, a measure that the recommendation system tracks and maintains. In broad terms the ‘susceptibility to respond’ indicates whether a user is likely to respond to any question at all, and then at a further granularity indicate the type of question the user is likely to respond to. All this is preferably based on the user's context. Concretely, over the lifetime of a user's experience with the system, the system may monitor within which contexts the user has been willing to respond to a simple binary or limited multiple choice question and, further, which contexts have seen the user willing to respond to a more complex question or questions. The system may further refine its measurement of this ‘susceptibility to respond’ by tracking which types of questions are answered under which contexts and so on. In this way, the system is effectively providing itself with a recommendation signal on when a particular style or pattern of question or questions may best be put to the user in the hope of getting a response. As such, the ‘susceptibility to respond’ recommendation signal can be construed and tracked by the system in the same way as any other action signal is recommended.

In constructing the question or questions, the system analyses one or more anomalies to determine efficient way of collecting the most meaningful response from the user. Furthermore, the system may cast a question in one or more forms.

Based on a determination that the user will respond to a question (step N3 of FIG. 5) then in step N4 of FIG. 5 the select template module 303 of the inquisition engine 408 will select an appropriate template from the templates module 304. The template will be chosen in dependence upon the determination of the complexity or simplicity of the question which the user is likely to respond to in the context and the metadata of the anomaly.

The templates stored in the templates module 304 will be pre-prepared, and there may be sets of templates associated with each type of response which a user will give to a question. Thus there may be sets of templates associated with simple questions, moderate questions, and complex questions. Each template will preferably have a set of standard wording, and within the standard wording there will be fields which are populated according to the anomaly. Thus the select template module 303 selects the appropriate template from the template module 304, and then the populate template module 305 adds the appropriate information for these fields to that template, and then the populated template is stored in the populated template module 306. The semantic analysis module 302 has analysed the anomaly for which textual description 301 is provided, and having been stored in the anomaly memory 407.

One type of recommendation message is in a format: action (verb)/object. For example: watch/movie title, or: go/run. This can be extended to include recommended actions such as “answer/simple question” or “answer/complex question.

In the above there has been described the general principle of the generation of a query message broadly based on anomaly metadata stored in the anomaly memory 407. There is now described a specific example of how the semantic analysis module operates in order to help determine a question to be put to a user. This relates to a use-case of, for example, a text-based use article, and it will be understood that this is not limiting. Examples of consumed content include, e.g., video.

This example is based on an analysis of a user engagement which has resulted in identification of an anomaly.

The semantic analysis module 302 (which is a semantic analysis engine) identifies a list of named entities found in the input text, each one represented by an entity object. There are two types of information associated to each entity:

Basic entity information, that is, the information specific to the element found. The basic entity information includes the form of the entity (i.e. what it is), how many times and in which form it appears in the text (variant_list), its global relevance (relevance), if it belongs to a specific dictionary (dictionary), and in the cases where it is a known entity, its unique identifier in the ontology and known standards (standard_list).

Semantic information—i.e. the different nodes (senses) to which the entity node is related to. There are different aspects of the semantic information: type of entity (sementity), geographical and thematic information (semgeo_list and semtheme_list) and other, more generic types (semrefer_list). For example, “Forbes” has three senses: a last name, a river in New South Wales and the Magazine. So in a situation with no disambiguation, three entities will be found, each with a different identifier that identifies the type of semantic entity identified.

For a full list of the fields that could appear in an entity object, see: https://www.meaningcloud.com/developer/topics-extraction/doc/1.2/response#entity

An example output of a semantic analysis engine, for the following input text, is provided below.

Input text:

“Robert Downey Jr has topped Forbes magazine's annual list of the highest paid actors for the second year in a row. The 49-year-old star of the Iron Man and Avengers films made an estimated $75 m over the past year, beating rivals Dwayne Johnson, Bradley Cooper, Chris Hemsworth and Leonardo DiCaprio.”

Output (note that this only a portion of the output and is shown for illustrative purposes):

```
{
    “status”: {
        “code”: “0”,
        “msg”: “OK”,
        “credits”: “25”
    },
    “entity_list”: [
        {
            “form”: “Robert Downey Jr”,
            “sementity”: {
                “class”: “instance”,
                “type”: “Top”,
                “confidence”: “unknown”
            },
            “variant_list”: [
                {
                    “form”: “Robert Downey Jr”,
                    “inip”: “0”,
                    “endp”: “15”
                }
            ],
            “relevance”: “100”
        },
        {
            “form”: “Forbes”,
            “id”: “4a3369b337”,
            “sementity”: {
                “class”: “instance”,
                “fiction”: “nonfiction”,
                “id”: “ODENTITY_LAST_NAME”,
                “type”: “Top>Person>LastName”
            },
            “semld_list”: [
                “sumo:LastName”
            ],
            “variant_list”: [
                {
                    “form”: “Forbes”,
                    “inip”: “28”,
                    “endp”: “33”
                }
            ],
            “relevance”: “100”
        },
        {
            “form”: “Forbes”,
            “id”: “9752b8b5ee”,
            “sementity”: {
                “class”: “instance”,
                “fiction”: “nonfiction”,
                “Id”: “ODENTITY_RIVER”,
                “type”:
“Top>Location>GeographicalEntity>WaterForm>River”
            },
            “semld_list”: [
                “sumo:River”
            ],
            “variant_list”: [
                {
                    “form”: “Forbes”,
                    “inip”: “28”,
                    “endp”: “33”
                }
            ],
            “relevance”: “100”
        },
        {
            “form”: “Forbes”,
            “id”: “db0f9829ff”,
            “sementity”: {
                “class”: “instance”,
                “fiction”: “nonfiction”,
                “id”: “ODENTITY_MAGAZINE”,
                “type”:
“Top>Product>CulturalProduct>Printing>Magazine”
            },
```

An administrator would then create queries that are able to use the entities identified in the analyzed text. For example:

If [content references a magazine] and [user not subscribed to magazine] then [select magazine news feed template] (Simple question example)

If [content references a magazine] and [user has not rated this magazine] and [magazine sections are known] then [select rating template that allows user to rate individual sections from the magazine] (Complex question example)

The queries and templates are created together, by the administrator. When the populated template is shown to the user and the user responds then the recommendation engine's future recommendations would be improved based on those responses.

For the example, the improvements might be:

If the user expresses an interest in receiving the magazine news feed, then preferentially weight future articles from that magazine's RSS feed. Or, offer a magazine subscription activity enticing the user to subscribe to the iPad or printed editions.

Use the rating the user gives to the magazine to adjust the weighting given to future stories from each of that magazine's sections. This is better than an existing recommendation system which would simply observe the user's engagement with a Forbes article and start recommending more without knowing how relevant that content is.

It will be appreciated that in some cases, the system needs a store of associated metadata for an entity (e.g. what sections does a given magazine have).

If the ‘susceptibility to respond’ signal indicates that the user is currently more likely to respond to a simple single question, then the system articulates its question thusly; moreover, if the user is likely willing to provide more thorough answers then a more complex question or questions may be presented.

A further example is now set out. A user living in London typically reads news stories about her local area together with stories in her field of work and those that relate to her hobbies. However, the system notices (step S2, FIG. 2) that she recently browsed to a webpage with a news article about Sydney, Australia. She spent enough time on the page and scrolled through it in a way consistent with someone reading the entire body of text (step S5, FIG. 2). The system identifies this as anomalous (step S4) because it was not a story that features highly, if at all, on any of the lists of news stories it might have recommended for her. It therefore gets added to a list of anomalies (step S5).

The following day, when she is at her desk at work, she clears her emails quicker than usual and has a moment or two to check Facebook. The system recognises this as a time when she has historically been happy to answer a simple yes/no question. As a result, it looks through its list of unresolved anomalies (step N2, FIG. 5) and picks out the Sydney, Australia one. For example, it may pick this one on the basis of FIRST IN, FIRST OUT, of the list. Alternatively, it could locate matching anomalies, e.g. all sharing “Australia”. Given the determined need to keep the answer short, it may pose a short question about the article, such as “Did you enjoy reading the story ‘5 things you didn't know about Sydney Harbour Bridge?’” Yes/No/More Options. This is shown in her portal at the UE as shown in FIG. 6.

If she responds, this information can be used by the system to adapt its news story recommendations decision making.

However, the example is continued by assuming that this context did not arise and the system has yet to resolve the anomaly. The following evening, the system detects (step S2, FIG. 2) that she is in a casual web browsing context as she has been online for a long period but is not spending much time on any particular web page. Historically, it has observed (by accumulating data from steps N6/N7 in FIG. 5) that this context generally means that she will be happy to answer a longer form question as she is bored. By analysing the anomaly itself, the system may pick out a number of features about it that can help it better understand her needs (see FIG. 3). A textual description 301 in the form of an electronic document is presented to the inquisition engine 408. From a simple semantic analysis 302 of the title and article in the document 301 it knows that the following entities are relevant:

Sydney, Australia: location, country

List based articles: article type

Holiday destinations: activity, event

Historic landmarks: locations, pastimes, hobbies.

The format is entity type: entity data.

Using this information, it can construct more detailed questions that will allow it to improve future recommendations of any action type, more accurately. By maintaining a set of question templates in the template store 304 for each type of entity identified in an article or as part of an anomalous user action, it can pose detailed questions. For this example, it might ask:

If you are going on holiday to Sydney, would you like me to add a weather widget to your home page and show the exchange rate?

Would you like to see other local news stories from that area for the next couple of weeks?

Are you interested in other historic landmarks in Sydney?—etc. . . .

Note that in the earlier example, the “More Options” choice would also have presented this more complex interaction. While these might seem quite sophisticated questions to infer from a viewed web page, they are supported by simple logical queries:

If [user location] is not equal to [location referred to by action] and [location referred to by action] is of type [holiday destination] then [select from holiday question templates]—if [currency] of [location referred to by action] is not equal to [currently] of [user location] then [select from exchange rate question templates]—etc. . . .

Note that “location referred to by action” is a location inferred from the anomalous item the user has chosen. The “user location” is part of the user contexts as described in the listed cases.

Answers to one or more of these questions can be entered by a user into the appropriate fields (shown in FIG. 6) for response. These responses are sent by way of feedback to the recommendation engine to allow the system to adapt its recommendation decision logic for a range of recommendable actions/content items. As mentioned, the system may base a question or questions on more than one observed anomaly if they look to be related. For example, if our user had no prior history of being interested in ‘numbered list’ style articles but then looked and read through several in a short period, then the most pressing question to the system might ask would be: “Would you like to see more articles that present content in easily digestible numbered list formats?” A more complex set of questions on this subject might have asked the user to provide feedback on some of the topics covered in each of the viewed number list articles.

In the recommendation system described herein, there are thus a number of unique features.

In a particularly stated example, a described process comprise the steps of:

1. Identifying and recording details of a user's content consumption anomalies;

2. Identifying the context in which the user is likely to be willing to answer questions, and if so the complexity of those questions;

3. Constructing one or more questions, using templates, that will allow the system to improve its understanding about the anomaly;

4. Providing the proceeds of these interactions back to the recommendation engine so that future recommendations may be improved.

Step 1 involves receiving a signal describing content consumption by a user. Content consumption may include watching, rating, liking, reading or any other action that indicates some sort of positive or negative engagement with an item of content or part thereof. The signal includes metadata that describes this activity and the content being consumed.

The system determines how likely it is that it would have recommended that item of content to the user. If the probability of doing so is determined to be below a particular threshold, then this is declared to be an anomaly.

It is important to note that the process is not constrained to signals arising from content which it has recommended. By being able to receive signals about any content consumption, the recommendation engine is able to accrue intelligence about the user that is not confined to engagement with its potentially limited supply of content. It therefore avoids a recommendation-resonance issue by which a recommendation engine, recommending content from its content store, receives signals in response to those recommendations which, being therefore a positive feedback loop, would tend to exaggerate the relevance of content that appeals to any given user such that items of content with good but not great relevance are recommended less and less frequently.

Step 2 may involve the use of a probability distribution function. For each permutation of user context, anomaly metadata and question complexity, there may be determined a probability of the user responding to such questions. This probability is affected by, amongst other things, signals from the user about their susceptibility to respond. For example: having been presented with a simple question but pressing the ‘More options’ button, or not watching content, or distracted from content etc. . . . techniques covered elsewhere but mentioned here by way of example.

Anomaly metadata describes the anomaly and may include information about the type of content giving rise to the anomaly (e.g. the user watched tennis and usually does not) or the consumption behaviour (e.g. the user normally watches an average of 50 minutes of football in a session with a S.D. of 4 mins, but today watched only 22 minutes), or other data that describes the identified anomaly.

The system may monitor its assessment of this probability function over time and, when the probability that the user will respond to questions about one or more anomalies rises above a given threshold, it may proceed to Step 3 and generate the questions of the indicated complexity.

When such an occasion arises, it may be that there is more than one anomaly about which questions may be asked. The system may decide to ask questions that allow it to understand all such anomalies (e.g. the user has started watching cat videos—all cat video views are separate anomalies, but the system may only need to ask ‘Are you sure about this cat video thing?’ in order to resolve all related anomalies); or it may ask one or more questions about the most unusual anomaly in the group (e.g. there are a set of anomalous football viewing sessions, one of which was only 5 minutes long; the system may choose this anomaly alone and ask one or more questions about it in particular), or a subset of anomalies (e.g. the user has started reading news articles from the New York Times, and mostly from the Style section, but also some from Technology and World News, but the system decides to ask questions only about the Style section anomalies).

Questions are constructed using question templates which are stored in a question template storage area. Templates are categorised as offering a particular level of complexity and as being appropriate for anomalies with particular anomaly metadata (e.g. a template may be a low complexity template that can be used to ask the user about unexpected genres of content consumption but is not suitable for use with anomalies that concern short-form content or radio broadcasts). The template may contain one or more parameterised questions such as “You [action parameter] [item parameter] on [time parameter]. Shall I start recommending more like this?” where [action parameter], [item parameter] and [time parameter] are filled in using information from the anomaly metadata. These are only examples of the kinds of parameters that may be present in a example question. Any data contained in the one or more anomalies' metadata may be used as a parameter.

When the system has asked one or more questions about one or more anomalies, these one or more anomalies are marked as resolved after which they are not used again to create questions.

All the examples and embodiments described herein may be implemented as processes in software. When implemented as processes in software, the processes (or methods) may be provided as executable code which, when run on a device having computer capability, implements a process or method as described. The execute code may be stored on a computer device, or may be stored on a memory and may be connected to or downloaded to a computer device.

The invention has been described above with reference to particular examples. The invention is not limited to any particular example set out. In particular the invention may be implemented by using parts of any example described. The invention also may be implemented by combining different parts of any described example. The scope of the invention is set forth in the appended claims.

1. A recommendation server comprising:
an input interface configured to receive an indication from a user device of a user behaviour;
a recommendation engine configured to compile recommendations for a user; and
a processor configured to identify an anomaly between the user behaviour and the compiled recommendations for the user.

2. A recommendation server according to claim 1 wherein the user behaviour is associated with a user engagement with the user device.

3. A recommendation according to claim 1 or claim 2 wherein the user behaviour is one or more of: a user choice of an item, a user action, or a user activity.

4. A recommendation server according to any one of claims 1 to 3 wherein the processor is configured to determine the anomaly in dependence on identification of the user behaviour as not being associated with recommendations for the user from which the compiled recommendations are collated.

5. A recommendation server according to any one of claims 1 to 3 wherein the processor is configured to determine the anomaly in dependence on identification of the user behaviour as not being associated with a compiled recommendation, but as being associated with a recommendation from which the compiled recommendations was collated.

6. The recommendation server of any one of claims 1 to 5 wherein the recommendation engine is further configured to compile recommendations for the user in dependence upon user context, and the processor is further configured to identify the anomaly in dependence on a context of the user behaviour.

7. The recommendation server of any one of claims 1 to 6 wherein the processor is configured to generate metadata describing the anomaly.

8. The recommendation server of any one of claims 1 to 7 further comprising a memory configured to store the identified anomaly.

9. The recommendation server of any one of claims 1 to 8, wherein if the context is a known context for the user, the known context is updated in dependence on the anomaly.

10. The recommendation server of any one of claims 1 to 8, wherein if the context is not a known context for the user, a new context is created for the user based on the anomaly.

11. The recommendation server of any one of claims 1 to 10 wherein the processor is configured to enhance future recommendations for the user in the same context based on the anomaly.

12. A computer-implemented method in a recommendation system comprising:
receiving an indication from a user device of a user behaviour;
compiling recommendations for a user to generate a list of compiled recommendation for the user; and
identifying an anomaly between the user behaviour and the list of compiled recommendations for the user.

13. The computer-implemented method of claim 1 wherein further comprising associating the user behaviour with a user engagement with the user device.

14. The computer-implemented method of claim 12 or claim 13 further comprising determining the anomaly in dependence on identification of the user behaviour as not being associated with recommendations for the user from which the compiled recommendations are collated.

15. The computer-implemented method of claim 12 or claim 13 further comprising determining the anomaly in dependence on identification of the user behaviour as not being associated with a compiled recommendation, but as being associated with a recommendation from which the compiled recommendations was collated.

16. The computer-implemented method of any one of claims 12 to 15 further comprising compiling the recommendations for the user in dependence upon user context, and identifying the anomaly in dependence on a context of the user behaviour.

17. The computer-implemented method of any one of claims 12 to 16 further comprising generating metadata describing the anomaly.

18. The computer-implemented method of any one of claims 12 to 17, further comprising updating a known context in dependence on the anomaly.

19. The computer-implemented method of any one of claims 12 to 17, further comprising creating a new context based on the anomaly.

20. The computer-implemented method of any one of claims 12 to 19 further comprising enhancing future recommendations for the user, in the same context, based on the anomaly.

21. A computer-implemented method of generating an enquiry message, the method comprising:
monitoring behaviour of a user when engaging with a computer device;
determining that the user has engaged with the user device in a particular context in which it is predetermined that the user will respond to the enquiry message;
selecting a template from a set of templates;
populating the selected template with data relating to the enquiry; and
transmitting the enquiry message to the user device based on the populated selected template.

22. The computer-implemented method of claim 21 wherein the set of templates include a plurality of sub-sets of templates, each sub-set being associated with a different enquiry complexity, the method further comprising determining an appropriate complexity for the enquiry based on the determined context, and selecting the template accordingly.

23. The computer-implemented method of claim 21 or 22 wherein the selected template is populated in dependence on metadata associated with the enquiry message.

24. The computer-implemented method of any one of claims 21 to 23 wherein the enquiry relates to a previous user behaviour.

25. The computer-implemented method of claim 24 wherein the enquiry relates to a relationship between a previous user behaviour and recommendations for the user.

26. The computer-implemented method of claim 25 wherein the enquiry relates to an anomaly identified between the previous user behaviour and recommendations for the user.

27. The computer-implemented method of any one of claims 21 to 26 wherein the step of selecting a template is further dependent on a user profile or user history data.

28. The computer-implemented method of any one of claims 21 to 27 further comprising receiving a response to the enquiry message, wherein the response is used to enhance future recommendations for the user.

29. A recommendation server comprising:
a recommendation engine configured to monitor behaviour of a user when engaging with a computer device;
a context module configured to determine that the user has engaged with the user device in a particular context in which it is predetermined that the user will respond to the enquiry message; and
an inquisition engine configured to:
select a template from a set of templates populating the selected template with data relating to the enquiry; and
transmit the enquiry message to the user device based on the populated selected template.

30. The recommendation server of claim 29 wherein the inquisition engine is further configured to select the template from a sub-set of templates, each sub-set being associated with a different enquiry complexity, in dependence on an appropriate complexity for the enquiry based on the determined context.

31. The recommendation server of claim 29 or 30 wherein the inquisition engine is configured to populated the template in dependence on metadata associated with the enquiry message.

32. The recommendation server of any one of claims 29 to 31 wherein the enquiry relates to a previous user behaviour.

33. The recommendation server of claim 32 wherein the enquiry relates to a relationship between a previous user behaviour and recommendations for the user.

34. The recommendation server of claim 32 wherein the enquiry relates to an anomaly identified between the previous user behaviour and recommendations for the user.

35. The recommendation server of any one of claims 29 to 34 wherein the inquisition engine is further configured to select the template further in dependence on a user profile or user history data.

36. The recommendation server of any one of claims 29 to 35 wherein the inquisition engine is further configured to receive response to the enquiry message, wherein the recommendation is further configured to enhance future recommendations for the user in dependence thereon.
